(19) United States
(12) Patent Application Publication
(10) Pub. No.: US 2005/0220320 A1
(43) Pub. Date: Oct. 6, 2005

(54) Speaker for mobile terminals and manufacturing method thereof

(76) Inventors: Kyung-Tae Kim, Kyunggi-do (KR); Jun-Woo Lim, Kyunggi-do (KR); Deok-Rae Kim, Kyunggi-do (KR); Ji-Won Kim, Kyunggi-do (KR)

Correspondence Address: GOTTLIEB RACKMAN & REISMAN PC, 270 MADISON AVENUE, 8TH FLOOR, NEW YORK, NY, 100160601, US

(21) Appl. No.: 10/910,760

(22) Filed: Aug. 3, 2004

(30) Foreign Application Priority Data
Mar. 30, 2004 (KR) 2004-21691

(51) Int. Cl. H04R 1/00; H04R 9/06

(52) U.S. Cl. 381/396; 381/398

(57) ABSTRACT

Disclosed herein are a speaker for mobile terminals which has a slim structure and has a wide frequency characteristic and an excellent high frequency distortion characteristic, thus accomplishing an excellent sound quality, and a method of manufacturing the speaker.

### BACKGROUND OF THE INVENTION

1. Field of the Invention

The present invention relates generally to a speaker for mobile terminals and a method of manufacturing the same, and more particularly, to a speaker for mobile terminals which has a slim structure and has a wide frequency characteristic and an excellent high frequency distortion characteristic, thus accomplishing an,excellent sound quality, and to a method of manufacturing the speaker.

2. Description of the Related Art

Recently, as a multimedia function has been rapidly supplied to a terminal for mobile telecommunications, an excellent sound quality has been accomplished. Further, as a thickness of a product is increasingly reduced, a space-economization type design with a thin frame is appealing.

As a size of a window of a liquid crystal display (LCD) is increased, a space to accommodate a speaker serving as an exit of sound is reduced. Thus, there is required a development of a new speaker which has both an excellent sound quality and a slim structure.

Generally, a speaker is a sounding device which transforms an acoustic signal received electrically or electro-magnetically into a sound audible to people. The speaker transduces electrical energy into mechanical energy by a voice coil provided in an air gap, according to Fleming's left-hand law. Fleming's left-hand law states that a conductor is subject to a magnetic force when the conductor in which a current flows is placed in a magnetic field.

That is, when a current signal including several frequencies is applied to the voice coil, the voice coil generates mechanical energy according to an intensity of current and a magnitude of frequency, and a diaphragm attached to the voice coil vibrates. As a result, a predetermined sound pressure, which is audible to people, is generated.

A magnetic circuit of such a speaker is designed so that a magnetic flux perpendicularly interlinks with the voice coil provided in the air gap, using a magnet and an upper plate which are provided in a yoke which is made of metal, such as steel. Because the voice coil is attached to the diaphragm, an electromotive force is generated in a vertical direction to vibrate the diaphragm adhered to the frame, thus generating a sound pressure.

Recently, owing to common use of a high energy magnet and a development of a microstructure forming technology, there has been continuously developed a speaker which is small and light and has high performance to satisfy a recent tendency of the information and communication field.

Further, as a terminal for mobile telecommunications has been rapidly spread, a micro-speaker is increasingly used. As the size of the speaker is reduced, size of parts included in the speaker is also reduced. However, a conventional design technology has a problem in that it is difficult to reduce the size of both the speaker and the parts included in the speaker.

FIG. 1 shows a conventional micro-speaker. As shown in FIG. 1, the speaker includes a frame 11 to define a space therein. A magnet 14 is installed in the frame 11 to be magnetized in a vertical direction. A yoke 12 provides a magnetic circuit along with the magnet 14. An upper plate 15 is attached to the magnet 14 to provide the magnetic circuit. The speaker also includes a diaphragm 16 to produce a sound. An outer edge of the diaphragm 16 is attached to an upper end of the frame 11. A voice coil 17 is mounted to a lower end of the diaphragm 16 to be wound in a form of a cylinder. A protective plate 19 covers an open end of the frame 11. A print circuit board (PCB) 20 is attached to a predetermined position of an outer surface of the frame 11.

Further, a plurality of air holes 18 are provided at predetermined positions of the frame 11 to allow air to be smoothly circulated when the diaphragm 16 vibrates.

FIG. 2 is a sectional view of the conventional speaker for mobile terminals. A voice coil 17, placed in an air gap between the yoke 12 and the upper plate 15, is attached to the diaphragm 16. Thus, when a current is applied to the voice coil 17, an electromotive force is generated in a vertical direction by a direction of a magnetic flux flowing in the upper plate 15 and the yoke 12 which are attached to the magnet 14 to be magnetized, and a current flowing in the voice coil 17. The electromotive force vibrates the diaphragm 16 attached to the frame 11, thus generating a sound pressure.

In the conventional micro-speaker constructed as described above, size of parts included in the speaker must be also reduced to construct a speaker of a slim structure. However, when the volume of the magnet 14 which determines a thickness of the speaker is reduced, a magnetic flux density becomes low. In this case, a sound pressure is reduced and thereby an excellent sound quality cannot be achieved.

Further, in the conventional micro-speaker, the voice coil 17 is attached to the lower end of the diaphragm 16 to be vertically wound in the form of a cylinder. Because the voice coil 17 is provided in the air gap between the upper plate 15 and the yoke 12, the voice coil 17 attached to the diaphragm 16 may collide with the upper plate 15 or the yoke 12 when the diaphragm 16 vibrates, thus causing a defective.

In order to solve the problems of the conventional speaker, there is required a speaker which is constructed to have a slim structure without reducing a volume of the magnet, and to prevent the voice coil from colliding with the upper plate or the yoke when the diaphragm vibrates.

In order to meet such a demand, there is proposed a thin speaker disclosed in Korea Patent Laid-Open Publication No. 2000-59016. According to Korea Patent Laid-Open Publication No. 2000-59016, the speaker is constructed so that a voice coil is printed on a lower surface of a diaphragm and a predetermined magnetic force is generated by external electricity, thus having a thin and slim structure.

The voice coil is printed on the lower surface of the diaphragm in a pattern of an eddy. In this case, the eddy may have a circular shape or a square shape.

In such a thin speaker, the voice coil is printed on the lower surface of the diaphragm. Thus, the thickness of the thin speaker is minimized, as compared to the conventional speaker in which the voice coil is wound in the form of the cylinder. As a result, the speaker of Korea Patent Laid-Open Publication No. 2000-59016 has an advantage in that a thin appliance is obtained, because a thickness of the appliance to which the speaker is adapted is reduced.

However, the thin speaker has a problem in that the voice coil printed on the diaphragm is wound in the pattern of the eddy, in a direction from a terminal provided on an outer portion of the diaphragm to a center of the diaphragm, and then the voice coil is wound in a reverse direction, starting from the center of the diaphragm, so that a direction of a current flowing from the terminal to the center of the diaphragm is opposite to a direction of a current flowing from the center to the outer portion of the diaphragm, thus offsetting electromagnetic forces. Therefore, a force to vibrate the diaphragm is reduced.

In such a thin speaker, a mutual magnetic interaction between the voice coil and a magnetic substance is weak, so that it is difficult to produce a high quality sound pressure. Thus, efficiency of the speaker is deteriorated.

Particularly, in the case of adapting the speaker, having the voice coil printed on the diaphragm as described above, to a small appliance, such as the mobile terminal, efficiency of the speaker is low and a high quality reproduced sound is not achieved, because a diameter of the speaker is about 15 mm.

### SUMMARY OF THE INVENTION

Accordingly, the present invention has been made keeping in mind the above problems occurring in the prior art, and an object of the present invention is to provide a speaker for mobile terminals which has a slim structure and has a wide frequency characteristic and an excellent high frequency distortion characteristic, thus accomplishing an excellent sound quality.

In order to accomplish the above object, the present invention provides a speaker for mobile terminals, including a frame to define a space therein, with a sidewall extending upward from an outer edge of the frame to a predetermined height, a support plate mounted to a lower end of the frame to provide a magnetic circuit, a first magnet placed at a center of an upper surface of the support plate and magnetized in a vertical direction, an annular second magnet placed to surround the first magnet and magnetized in a vertical direction so that a magnetic pole direction of the second magnet is opposite to a magnetic pole direction of the first magnet, a diaphragm provided at a position above the first and second magnets to produce a sound, with a plurality of voice coils being integrally printed on the diaphragm to form a multilayer and generating a predetermined magnetic force by external drive electricity, and a protective plate to cover an open end of the frame.

The diaphragm includes a first polymeric resin film, the plurality of voice coils comprising upper and lower voice coils respectively printed on upper and lower surfaces of the first polymeric resin film, and a second polymeric resin film to cover each of the upper and lower voice coils, thus preventing the upper and lower voice coils from corroding.

Further, each of the upper and lower voice coils is printed in a pattern of an eddy, starting from an input terminal or an output terminal provided on an outer portion of the diaphragm so that the external drive electricity is input to the input terminal and output from the output terminal, with a via hole being provided at a center of the eddies of the upper and lower voice coils to conduct the electricity between the upper and lower voice coils printed on the upper and lower surfaces of the first polymeric resin film.

A direction of the eddy of the upper voice coil printed on the upper surface of the first polymeric resin film is opposite to a direction of the eddy of the lower voice coil printed on the lower surface of the first polymeric resin film, so that a direction of a current flowing in the upper voice coil is the same as a direction of a current flowing in the lower voice coil.

An auxiliary vibration piece may be provided at an edge of the diaphragm to allow the diaphragm to smoothly vibrate. Preferably, the auxiliary vibration piece is made of a soft rubber or an elastomer.

The support plate includes a support protrusion to support the first and second magnets at desired positions on the support plate so that an air gap is defined between the first and second magnets. An air hole is provided at a predetermined portion of the support protrusion to allow atmospheric air to circulate through the air gap when the diaphragm vibrates.

A plurality of air holes may be provided at predetermined positions of the frame.

The support plate is integrated with the frame into a single structure through an insert molding process.

Further, the speaker of this invention includes a second support plate attached to a lower surface of the protective plate to provide a magnetic circuit, and a third magnet attached to a lower surface of the second support plate and magnetized in a vertical direction so that a magnetic pole direction of the third magnet is opposite to the magnetic pole direction of the first magnet.

Further, an annular fourth magnet may be provided at a position above the diaphragm. In this case, the annular fourth magnet is placed to surround the third magnet and magnetized so that a magnetic pole direction of the fourth magnet is opposite to the magnetic pole direction of the third magnet. Thus, the third and fourth magnets are arranged at the inside and outside portions in the frame.

In order to accomplish the above object, the present invention provides a method of manufacturing a speaker for mobile terminals, which includes forming a frame to be integrated with a support plate which provides a magnetic circuit, attaching a first magnet vertically magnetized to an upper surface of the support plate and attaching a second magnet, magnetized in a direction opposite to a magnetic pole direction of the first magnet, to the upper surface of the support plate so that the second magnet is spaced apart from the first magnet at a predetermined interval, forming upper and lower voice coils on upper and lower surfaces of a first polymeric resin film to provide a multilayer and laminating second polymeric resin films to prevent corrosion of the upper and lower voice coils and insulate the upper and lower voice coils, thus forming a diaphragm, attaching the diaphragm to the frame so that an outer edge of the diaphragm is supported by an upper end of the frame, placing a protective plate on the frame to cover an open end of the frame, and welding input and output terminals of the upper and lower voice coils to a terminal piece of a printed circuit board (PCB).

The forming of the diaphragm includes coating an adhesive agent on the upper and lower surfaces of the first polymeric resin film, and attaching a copper film to each of the upper and lower surfaces of the first polymeric resin film, and etching a surface of the copper film, thus forming a pattern of each of the upper and lower voice coils.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view of a conventional speaker for mobile terminals;

FIG. 2 is a sectional view of the speaker of FIG. 1;

FIG. 3 is an exploded perspective view of a speaker for mobile terminals, according to the first embodiment of the present invention;

FIG. 4 is a sectional view of the speaker of FIG. 3;

FIG. 5 is a detailed sectional view of a diaphragm included in the speaker of FIG. 3;

FIG. 6 is a plan view to show an upper surface of the diaphragm of FIG. 5;

FIG. 7 is a plan view to show a lower surface of the diaphragm of FIG. 5;

FIG. 8 is an exploded perspective view of a speaker for mobile terminals, according to the second embodiment of the present invention;

FIG. 9 is a sectional view of the speaker of FIG. 8;

FIG. 10 is a sectional view of a speaker for mobile terminals, according to the third embodiment of the present invention; and

FIG. 11 is a sectional view of a speaker for mobile terminals, according to the fourth embodiment of the present invention.

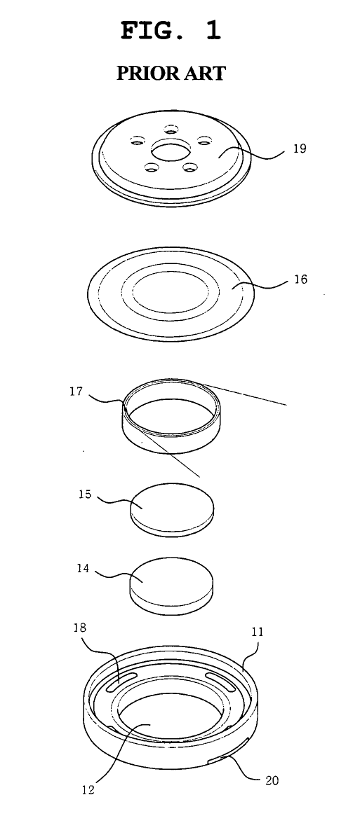

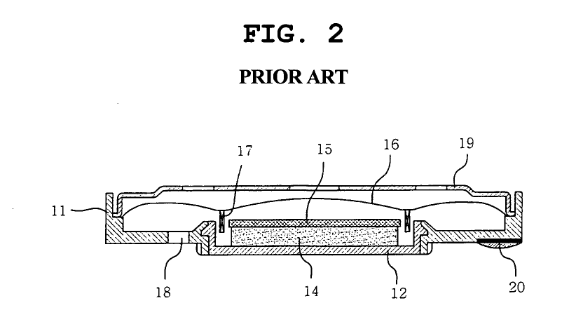

### DESCRIPTION OF THE PREFERRED EMBODIMENTS

Hereinafter, embodiments of the present invention will be described in detail with reference to the attached drawings.

Reference now should be made to the drawings, in which the same reference numerals are used throughout the different drawings to designate the same or similar components.

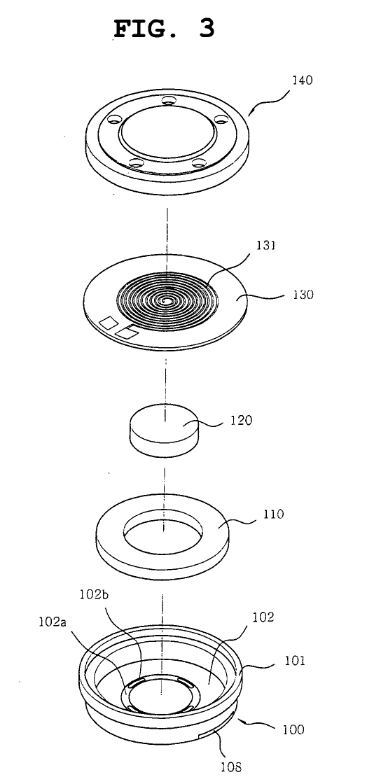

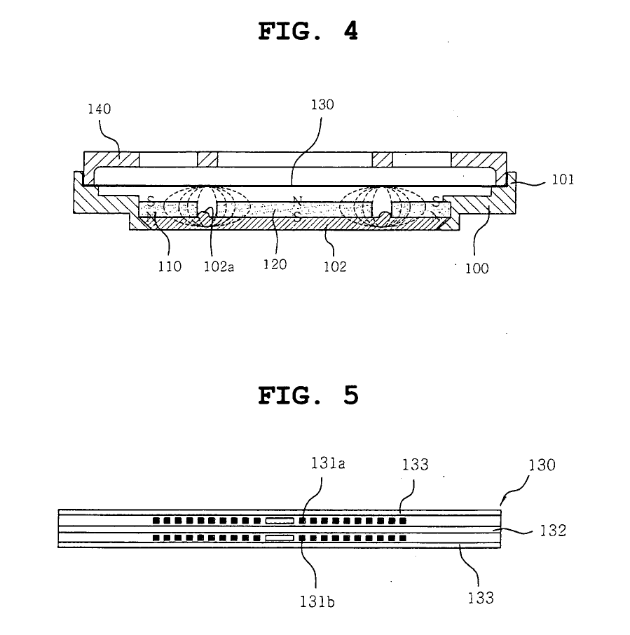

FIG. 3 is an exploded perspective view of a speaker for mobile terminals, according to the first embodiment of the present invention. FIG. 4 is a sectional view of the speaker of FIG. 3. The speaker according to the first embodiment will be described in the following with reference to FIGS. 3 and 4.

According to the first embodiment of the present invention, the speaker for mobile terminals includes a frame 100, a support plate 102, a first magnet 120, a second magnet 110, a diaphragm 130, and a protective plate 140. The frame 100 defines a space therein, with a sidewall 101 extending upward from an outer edge of the frame 100 to a predetermined height. The support plate 102 is mounted to a lower end of the frame 100 to provide a magnetic circuit. The first magnet 120 is placed at a center of an upper surface of the support plate 102, and is magnetized in a vertical direction. The second magnet 110 is placed to surround the first magnet 120, and is magnetized in a vertical direction so that a magnetic pole direction of the second magnet 110 is opposite to that of the first magnet 120. The diaphragm 130 is provided at a position above the first and second magnets 120 and 110 to produce a sound. A plurality of voice coils 131 are integrally printed on the diaphragm 130 to form a multilayer, and generates a predetermined magnetic force by external drive electricity. The protective plate 140 covers an open end of the frame 100.

Preferably, the frame 100 is made of a non-magnetic material and manufactured through an injection molding process, in order to prevent a loss of magnetic forces of the first and second magnets 110 and 120.

Further, according to the first embodiment of this invention, the frame 100 has a circular shape. However, the frame 100 may have various shapes, such as a rectangular shape, an elliptical shape, a track shape, without being limited to the circular shape.

Preferably, the support plate 102 is made of a ferromagnetic material with high permeability, such as steel.

Further, the support plate 102 and the frame 100 may be separately manufactured and then assembled with each other. Alternatively, the support plate 102 and the frame 100 may be integrated with each other into a single structure. In the case where the support plate 102 and the frame 100 are separately manufactured, edges of the support plate 102 and the frame 100 have corresponding slant surfaces or stepped surfaces so that the support plate 102 and the frame 100 are assembled with each other at the slant surfaces or the stepped surface. Meanwhile, in the case where the support plate 102 and the frame 100 are integrated with each other, the support plate 102 is manufactured through an insert molding process during a molding process of the frame 100.

Further, a support protrusion 102a is provided at a predetermined position of the support plate 102 to support the first and second magnets 120 and 110 at desired positions on the support plate 102.

The support protrusion 102a is placed around an outer circumferential surface of the first magnet 120 so that an air gap is defined between the first and second magnets 120 and 110. By the support protrusion 102a, the first and second magnets 120 and 110 are supported at desired positions on the support plate 102.

Further, a plurality of air holes 102b are provided at predetermined positions of the support protrusion 102a to allow atmospheric air to circulate through the air gap when the diaphragm 130 vibrates, thus allowing the diaphragm 130 to smoothly vibrate.

In this case, it is preferable that the air holes 102b be provided to be symmetric with respect to each other. That is, when the air holes 102 are symmetrically provided, a split vibration is avoided during the vibration of the diaphragm 130, thus preventing a sound quality from being deteriorated.

According to the first embodiment, the air holes 102b are provided at the predetermined positions of the support protrusion 102a. However, the air holes 102b may be provided at other positions, without being limited to the support protrusion 102a.

For example, the air holes 102b may be provided at the frame 100. Even when the air holes 102b are provided at the frame 100, it is preferable that the air holes 102b be symmetrically provided.

The first magnet 120 has a circular shape to conform to the shape of the frame 100, while the second magnet 110 has an annular shape to surround the first magnet 120.

In this invention, the first and second magnets 120 and 110 must be magnetized so that the magnetic pole direction of the first magnet 120 is opposite to that of the second magnet 110.

That is, as shown in FIG. 4, when the first magnet 120 is magnetized so that a north pole is placed on an upper end of the first magnet 120 and a south pole is placed on a lower end of the first magnet 120, the second magnet 110 is magnetized so that a south pole is placed on an upper end of the second magnet 110 and a north pole is placed on a lower end of the second magnet 110, thus forming a magnetic flux in a horizontal direction by a magnetic field.

The first and second magnets 120 and 110 are adhered to each other using various kinds of adhesive means. Preferably, the first and second magnets 120 and 110 are attached to each other using a hot-sheet or a heat-adhesive tape.

In the first embodiment of this invention, it is preferable that each of the first and second magnets 120 and 110 comprise a neodymium magnet which is small in size and has a strong magnetic force.

Because a rare earth magnet, e.g., the neodymium magnet has a very strong magnetic force, the neodymium magnet is widely used for a high-technology product which is light, thin, small, and compact. The neodymium magnet-type speaker is integrally mounted to a notebook computer, a small-sized personal computer, a slim computer, or an LCD monitor, etc.

The diaphragm 130 where the plurality of voice coils 131 are printed to form the multilayer is provided at a position above the first and second magnets 120 and 110. The construction of the diaphragm 130 employed on the first embodiment of the present invention is shown in FIGS. 5 through 7 in detail.

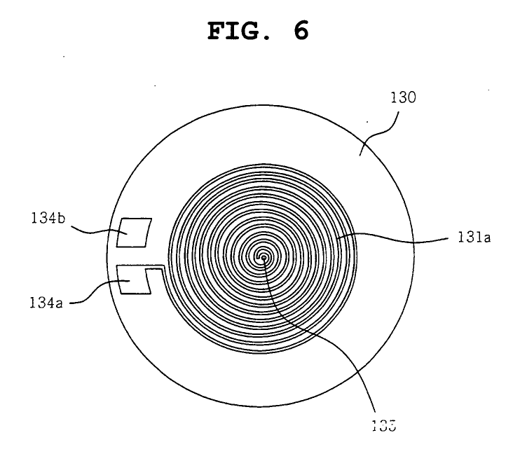

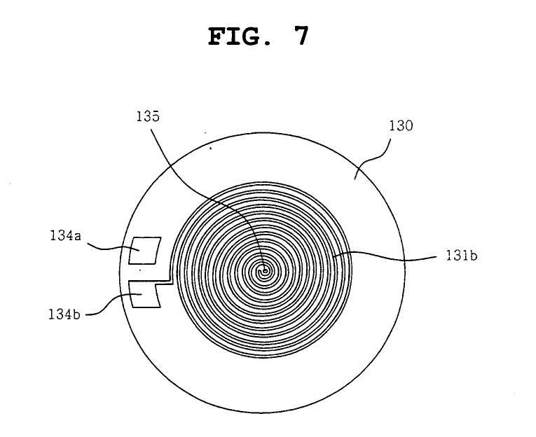

FIG. 5 is a detailed sectional view of the diaphragm included in the speaker of FIG. 3. FIG. 6 is a plan view to show an upper surface of the diaphragm of FIG. 5. FIG. 7 is a plan view to show a lower surface of the diaphragm of FIG. 5.

The diaphragm 130 includes a first polymeric resin film 132. Upper and lower voice coils 131a and 131b are respectively printed on the upper and lower surfaces of the first polymeric resin film 132. Two second polymeric resin film 133 cover the upper and lower voice coils 131a and 131b, respectively, so as to prevent the upper and lower voice coils 131a and 131b from corroding.

That is, the upper and lower voice coils 131a and 131b are printed on the first polymeric resin film 132. In order to provide such a diaphragm 130, an adhesive agent is coated on the upper and lower surfaces of the first polymeric resin film 132. Next, a copper film is attached to each of the upper and lower surfaces of the first polymeric resin film 132. A surface of the copper film is etched, thus forming a pattern of each of the upper and lower voice coils 131a and 131b. Thereafter, the second polymeric resin film 133 covers each of the upper and lower voice coils 131a and 131b, thus preventing the upper and lower voice coils 131a and 131b from corroding.

As such, a conductive material, such as copper, is deposited on the diaphragm 130 to form the upper and lower voice coils 131a and 131b. Thus, the upper and lower voice coils 131a and 131b are integrated with the diaphragm 130 into a single structure.

In this case, each of the upper and lower voice coils 131a and 131b has a thickness of several micrometers (μm). Each of the upper and lower voice coils 131a and 131b has a pattern of an eddy.

In a detailed description, input and output terminals 134a and 134b are provided on an outer portion of the diaphragm 130, with external drive electricity being input to and output from the input and output terminals 134a and 134b, respectively. The upper and lower voice coils 131a and 131b are printed in the pattern of the eddy, starting from the input and output terminals 134a and 134b.

According to the first embodiment of the present invention, because the upper and lower voice coils 131a and 131b are printed on the diaphragm 130 to form a double-layer, a via hole 135 is formed at a center of the eddies of the upper and lower voice coils 131a and 131b to conduct the electricity between the upper voice coil 131a printed on the upper surface of the first polymeric resin film 132 and the lower voice coil 131b printed on the lower surface of the first polymeric resin film 132.

The diaphragm 130 constructed as described above is operated as follows. The drive electricity is input to the input terminal 134a. Next, the drive electricity flows in the upper voice coil 131a, printed on the upper surface of the first polymeric resin film 132, in the pattern of the eddy, and is transmitted to the lower voice coil 131b printed on the lower surface of the first polymeric resin film 132 through the via hole 135. Subsequently, the drive electricity flows in the lower voice coil part 131b printed on the lower surface of the first polymeric resin film 132 in the pattern of the eddy, and then is output from the output terminal 134b.

In this case, the upper and lower voice coils 131a and 131b must be respectively printed on the upper and lower surfaces of the first polymeric resin film 132 so that a direction of the eddy of the upper voice coil 131a is opposite to a direction of the eddy of the lower voice coil 131b.

For example, in the case where the upper voice coil 131a is printed to have a pattern of a clockwise eddy, the lower voice coil 131b must be printed to have a pattern of a counterclockwise eddy. Conversely, in the case where the upper voice coil 131a is printed to have a pattern of a counterclockwise eddy, the lower voice coil 131b must be printed to have a pattern of a clockwise eddy.

As such, when a direction of the eddy of the upper voice coil 131a is opposite to a direction of the eddy of the lower voice coil 131b, a direction of a current flowing in the upper voice coil 131a is equal to a direction of a current flowing in the lower voice coil 131b, thus doubling current efficiency.

In the diaphragm 130 of this invention, the voice coils 131 are doubly printed in such a way that the direction of the current flowing in the upper voice coil 131a is the same as the direction of the current flowing in the lower voice coil 131b, thus doubling current efficiency and thereby increasing a force to vibrate the diaphragm 130.

In the first embodiment is disclosed the diaphragm 130 on which the upper and lower voice coils 131a and 131b are printed to form the double-layer. However, according to the present invention, the plurality of voice coils 131 may be printed on the diaphragm 130 to form a multilayer.

Further, impedance of the speaker can be controlled by a thickness and a pattern's width of each upper and lower voice coils 131a and 131b. A non-woven fabric may be attached to the speaker to control a flow of air.

At a predetermined position of the frame 100 is provided a terminal piece (not shown) of a printed circuit board (PCB) 108 to which the input and output terminals 134a and 134b of the voice coils 131 are welded.

In the speaker constructed as described above, the annular second magnet 110 is placed to surround the first magnet 120. The first and second magnets 120 and 110 are magnetized so that a magnetic pole direction of the first magnet 120 is opposite to a magnetic pole direction of the second magnet 110. Further, the voice coils 131 are provided above the first and second magnets 120 and 110. Thus, a direction of a magnetic flux passing through the voice coils 131 is orthogonal to a direction of a current flowing in the voice coils 131.

In the magnetic circuit of this invention, the magnetic flux has a horizontal direction so that the direction of the magnetic flux is perpendicular to the direction of the current flowing in the voice coils 131. The magnetic circuit vibrates the diaphragm 130 which is adhered to the frame 100 so as to produce a sound pressure, thus accomplishing high magnetic efficiency.

The speaker of this invention is constructed so that a direction of a magnetic field generated by the first magnet 120 is the same as a direction of a magnetic field generated by the second magnet 110. Thus, a direction of a line of magnetic force of the first magnet 120 is equal to a direction of a line of magnetic force of the second magnet 110, thus increasing a magnetic flux, therefore obtaining a higher output when the same amount of electricity is input.

The process of manufacturing the speaker for mobile terminals according to the present invention is as follows. First, the support plate 102 which provides the magnetic circuit is manufactured to be integrated with the frame 100. The first magnet 120 which is magnetized in the vertical direction is attached to the upper surface of the support plate 102. Next, the second magnet 110 magnetized in a direction opposite to the magnetic pole direction of the first magnet 120 is attached to the support plate 102 so that the second magnet 120 is spaced apart from the first magnet 120 at a predetermined interval. The diaphragm 130 having the voice coils 131, which are printed on the upper and lower surfaces of the first polymeric resin film 132, is mounted to an upper end of the frame 100. Thereafter, the protective plate 140 is placed on the frame 100 to cover the open end of the frame 100.

Further, the input and output terminals 134a and 134b of the voice coils 131 are welded to predetermined portions of the terminal piece of the PCB 108, thus connecting the voice coils 131 to the PCB 108. Thereby, the manufacture of the speaker is completed.

Since the upper and lower voice coils 131a and 131b are printed on the diaphragm 130 to form the double-layer, and a direction of a current flowing in the upper voice coil 131a is equal to a direction of a current flowing in the lower voice coil 131b, the speaker of this invention doubles current efficiency, as compared to the conventional thin speaker, thus increasing force to vibrate the diaphragm 130.

Further, the speaker of this invention is constructed so that the first and second magnets 120 and 110 are arranged at the inside and outside portions in the frame 100, so that a magnetic action between the voice coils 131 and the first and second magnets 120 and 110 is strong. Thus, a high quality sound pressure is generated, thus increasing efficiency of the speaker.

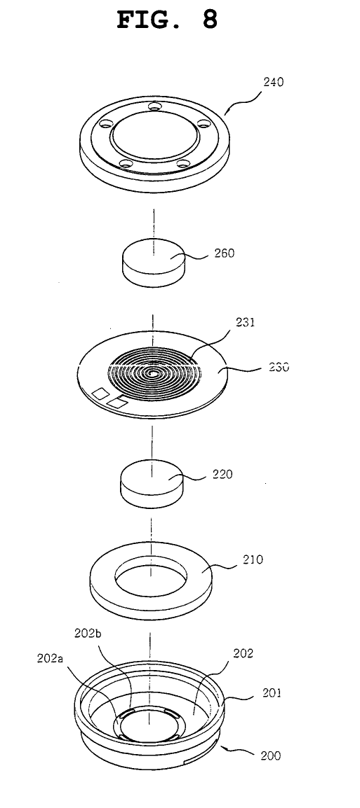

FIG. 8 is a perspective view to show a speaker for mobile terminals, according to a second embodiment of this invention.

The speaker of the second embodiment includes a frame 200. A first support plate 202 is attached to a lower end of the frame 200 to provide a magnetic circuit. A first magnet 220 is placed at a center of an upper surface of the first support plate 202, and is magnetized vertically. An annular second magnet 210 is placed to surround the first magnet 220, and is magnetized vertically so that a magnetic pole direction of the second magnet 210 is opposite to a magnetic pole direction of the first magnet 220. Further, a diaphragm 230, which functions to produce a sound, is provided at a position above the first and second magnets 220 and 210. A plurality of voice coils 231 are integrally printed on the diaphragm 230 to form a multilayer, and generate a predetermined magnetic force. The speaker also has a protective plate 240 to cover an open end of the frame 200.

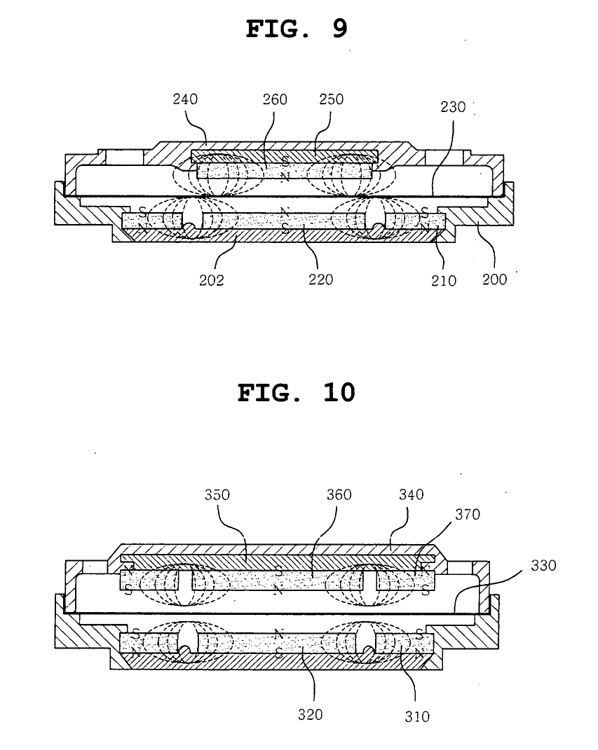

In the second embodiment of this invention, as shown in FIG. 9, a second support plate 250 is attached to a lower surface of the protective plate 240 to provide a magnetic circuit. Further, a third magnet 260 is mounted to a lower surface of the second support plate 250, and is vertically magnetized so that a magnetic pole direction of the third magnet 260 is opposite to the magnetic pole direction of the first magnet 220.

That is, as shown in FIG. 9, the speaker of the second embodiment further includes the third magnet 260 which is magnetized so that a north pole is placed on a lower end of the third magnet 260 and a south pole is placed on an upper end of the third magnet 260, when the first magnet 220 is magnetized so that a north pole is placed on an upper end of the first magnet 220 and a south pole is placed on a lower end of the first magnet 220.

As such, the speaker of the second embodiment further includes the circular third magnet 260 which is provided at a position above the diaphragm 230, thus providing a stronger electromagnetic force to the diaphragm 230, and allowing a vertical vibration of the diaphragm 230 to be more smoothly carried out.

Referring to an upper part of the speaker, it is preferable that the second support plate 250 be integrated with the protective plate 240 through an insert molding process. In this case, a stepped part is provided at an edge of a circumference of the second support plate 250 to be supported by the protective plate 240.

The construction of the diaphragm 230 of the second embodiment remains the same as the diaphragm 130 of the first embodiment. According to the second embodiment, the voice coils 231 are integrally printed on the diaphragm 230 to form the multilayer.

The diaphragm 230 includes a first polymeric resin film. The voice coils 231 are respectively printed on upper and lower surfaces of the first polymeric resin film. A second polymeric resin film covers each of the voice coils 231 so as to prevent the voice coils 231 from corroding. In this case, each voice coil 231 is printed in a pattern of an eddy.

Further, a via hole is formed at a center of the eddy to conduct electricity between the voice coil 231 printed on the upper surface of the first polymeric resin film and the voice coil 231 printed on the lower surface of the first polymeric resin film. First, drive electricity is input to an input terminal. The electricity flows in the voice coil 231 printed on the upper surface of the first polymeric resin film in the pattern of eddy, and then is transmitted to the voice coil 231 printed on the lower surface of the first polymeric resin film through the via hole. Next, the electricity flows in the voice coil 231 printed on the lower surface of the polymeric resin film in the pattern of eddy, and then is output from an output terminal.

In this case, the voice coils 231 must be printed on the upper and lower surfaces of the first polymeric resin film so that a direction of the eddy of the upper voice coil 231 is opposite to a direction of the eddy of the lower voice coil 231.

Thus, the direction of the current flowing in the upper voice coil 231 is the same as the direction of the current flowing in the lower voice coil 231, thus doubling current efficiency.

Further, a support protrusion 202a is provided at a predetermined position of the first support plate 202 to support the first and second magnets 220 and 210 at desired positions on the first support plate 202. A plurality of air holes 202b are provided at predetermined positions of the support protrusion 202a to allow atmospheric air to circulate through the air gap when the diaphragm 230 vibrates, thus allowing the diaphragm 230 to smoothly vibrate.

In this case, it is preferable that the air holes 202b be provided to be symmetric with respect to each other. The air holes 202b may be provided at other positions, without being limited to the support protrusion 202a.

The thin speaker according to the second embodiment includes the planar diaphragm 230. The voice coils 231 are printed on a same plane of the diaphragm 230. Since the voice coils 231 are doubly printed and a direction of the current flowing in the upper voice coil 231 is equal to a direction of the current flowing in the lower voice coil 231, the current efficiency is doubled as compared to a conventional thin speaker, thus increasing a force to vibrate the diaphragm 230.

The first and second magnets 220 and 210 are mounted to a lower portion of the speaker so that the first and second magnets 220 and 210 are arranged at the inside and outside portions in the frame 200. Further, the circular third magnet 260 is provided at a position above the diaphragm 260. The second support plate 250 is mounted on the third magnet 260. Thus, a stronger magnetic circuit is achieved, thus generating a high quality sound pressure, therefore increasing efficiency of the speaker.

FIG. 10 is a sectional view of a speaker for mobile terminals, according to the third embodiment of the present invention. In the speaker of the third embodiment, magnets are installed at an upper portion of the speaker so that the magnets are arranged at the inside and outside portions in a frame, thus intensifying a magnetic field.

According to the third embodiment, a second support plate 350 is mounted to a lower surface of a protective plate 340 to provide a magnetic circuit. To a lower surface of the second support plate 350 are mounted a third magnet 360 and a fourth magnet 370. In this case, the third magnet 360 is magnetized vertically so that a magnetic pole direction of the third magnet 360 is opposite to a magnetic pole direction of the first magnet 320. The annular fourth magnet 370 surrounds the third magnet 360.

In this case, the fourth magnet 370 is magnetized so that a magnetic pole direction of the fourth magnet 370 is opposite to a magnetic pole direction of the third magnet 360.

In a detailed description, as shown in FIG. 10, when the first magnet 320 is magnetized so that a north pole is placed at an upper end of the first magnet 320 and a south pole is placed at a lower end of the first magnet 320, the second magnet 310 is magnetized so that a south pole is placed at an upper end of the second magnet 310 and a north pole is placed at a lower end of the second magnet 310, thus forming a magnetic flux in a horizontal direction by a magnetic field. Further, the third magnet 360 is magnetized so that the magnetic pole direction thereof is opposite to the magnetic pole direction of the first magnet 320. Thus, a north pole is placed at a lower end of the third magnet 360, while a south pole is placed at an upper end of the third magnet 360. Further, the fourth magnet 370 is magnetized so that a north pole is placed at an upper end of the fourth magnet 370 and a south pole is placed at a lower end of the fourth magnet 370.

That is, magnetic pole directions of the third and fourth magnets 360 and 370 provided at the upper portion of the speaker are opposite to the magnetic pole directions of the first and second magnets 320 and 310, respectively.

As such, the speaker according to the third embodiment further includes the circular third magnet 360 and the annular fourth magnet 370 at positions above the diaphragm 330, thus providing a stronger electromagnetic force to the diaphragm 330, therefore enhancing the performance of the speaker.

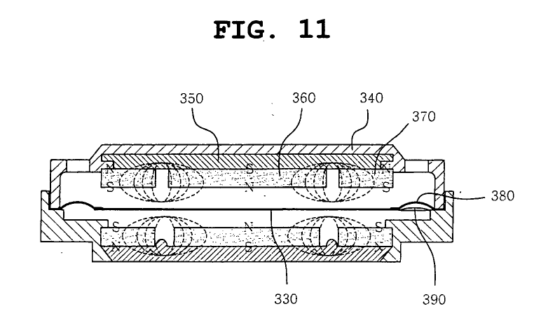

FIG. 11 is a sectional view of a speaker for mobile terminals, according to the fourth embodiment of the present invention. According to the fourth embodiment, an auxiliary vibration piece 380 is attached to an edge of the diaphragm 330 to allow the diaphragm 330 to smoothly vibrate.

Preferably, the auxiliary vibration piece 380 is made of a soft rubber or an elastomer.

Further, a lead wire 390 is provided at a predetermined portion of the diaphragm 330 to input a signal to the voice coils printed on the diaphragm 330, thus allowing an exterior signal to be transmitted to the voice coils.

According to the fourth embodiment, the auxiliary vibration piece 380 made of the soft rubber or the elastomer is attached to the edge of the diaphragm 330, thus allowing the diaphragm 330 to more smoothly vibrate.

Further, according to the fourth embodiment, the third and fourth magnets 360 and 370 are provided at predetermined positions above the diaphragm 330. Of course, the auxiliary vibration piece 380 attached to the edge of the diaphragm 330 may be applied to the speaker according to first or second embodiment of this invention.

As described above, the present invention provides a speaker for mobile phones, which is constructed so that voice coils are integrally printed on a diaphragm, and first and second magnets are arranged at the inside and outside portions in a frame to provide a combination of inner and outer magnetic circuits, thus considerably reducing the thickness of the speaker, and generating a high quality sound pressure.

Further, voice coils are printed on a diaphragm to reinforce the strength of the diaphragm, thus accomplishing a thin and flat structure while ensuring a wide frequency characteristic and an excellent high frequency distortion characteristic, therefore providing a natural and clear sound.

In the combination of the inner and outer magnetic circuits, two magnets are arranged at the inside and outside portions in a frame so that a magnetic pole direction of one of the magnets is opposite to a magnetic pole direction of a remaining one of the magnets, thus forming a repulsive magnetic field. In this case, a magnetic flux is generated in a horizontal direction, so that the direction of the magnetic flux is orthogonal to a direction of a current flowing in the voice coil, thus accomplishing high magnetic efficiency.

Further, planar voice coils are integrated with a diaphragm having a polymeric resin film, thus simplifying a process of assembling the diaphragm with the voice coils which is typically considered as an important process, therefore remarkably reducing defective which may occur when the voice coil is assembled with the diaphragm.

Thus, lead time required to produce a speaker is reduced.

Further, voice coils are printed on upper and lower surfaces of a diaphragm so that an eddy direction of one of the voice coils is opposite to an eddy direction of the remaining one of the voice coils. Thereby, a direction of a current flowing in one of the voice coils is equal to a direction of a current flowing in the remaining one of the voice coils, thus doubling current efficiency, therefore providing a speaker of high performance.

Furthermore, in order to maximize efficiency in an air gap, magnets having different polarities are arranged at the inside and outside portions in a frame, and magnets having the same polarities are vertically arranged to face each other, thus providing a speaker of a sandwich structure. Such a structure allows a magnetic flux to be formed in a horizontal direction due to a repulsive magnetic field.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A speaker for mobile terminals, comprising:
a frame to define a space therein, with a sidewall extending upward from an outer edge of the frame to a predetermined height;
a support plate mounted to a lower end of the frame to provide a magnetic circuit;
a first magnet placed at a center of an upper surface of the support plate, and magnetized in a vertical direction;
an annular second magnet placed to surround the first magnet, and magnetized in a vertical direction so that a magnetic pole direction of the second magnet is opposite to a magnetic pole direction of the first magnet;
a diaphragm provided at a position above the first and second magnets to produce a sound, with a plurality of voice coils being integrally printed on the diaphragm to form a multilayer and generating a predetermined magnetic force by external drive electricity; and
a protective plate to cover an open end of the frame.

2. The speaker for mobile terminals according to claim 1, wherein the diaphragm comprises:
a first polymeric resin film;
the plurality of voice coils comprising upper and lower voice coils respectively printed on upper and lower surfaces of the first polymeric resin film; and
a second polymeric resin film to cover each of the upper and lower voice coils, thus preventing the upper and lower voice coils from corroding.

3. The speaker for mobile terminals according to claim 2, wherein each of the upper and lower voice coils is printed in a pattern of an eddy, starting from an input terminal or an output terminal provided on an outer portion of the diaphragm so that the external drive electricity is input to the input terminal and output from the output terminal, with a via hole being provided at a center of the eddies of the upper and lower voice coils to conduct the electricity between the upper and lower voice coils printed on the upper and lower surfaces of the first polymeric resin film.

4. The speaker for mobile terminals according to claim 3, wherein a direction of the eddy of the upper voice coil printed on the upper surface of the first polymeric resin film is opposite to a direction of the eddy of the lower voice coil printed on the lower surface of the first polymeric resin film, so that a direction of a current flowing in the upper voice coil is the same as a direction of a current flowing in the lower voice coil.

5. The speaker for mobile terminals according to any one of claims 1 to 4, further comprising:
an auxiliary vibration piece provided at an edge of the diaphragm to allow the diaphragm to smoothly vibrate.

6. The speaker for mobile terminals according to claim 5, wherein the auxiliary vibration piece is made of a soft rubber or an elastomer.

7. The speaker for mobile terminals according to claim 1, wherein the support plate comprises a support protrusion to support the first and second magnets at desired positions on the support plate so that an air gap is defined between the first and second magnets.

8. The speaker for mobile terminals according to claim 7, further comprising:
an air hole provided at a predetermined portion of the support protrusion to allow atmospheric air to circulate through the air gap when the diaphragm vibrates.

9. The speaker for mobile terminals according to claim 1, further comprising:
a plurality of air holes provided at predetermined positions of the frame.

10. The speaker for mobile terminals according to claim 1, wherein an inner edge of the frame and an outer edge of the support plate have corresponding slant surfaces so that the support plate is assembled with the frame at the slant surfaces.

11. The speaker for mobile terminals according to claim 1, wherein an inner edge of the frame and an outer edge of the support plate have corresponding stepped surfaces so that the support plate is assembled with the frame at the stepped surfaces.

12. The speaker for mobile terminals according to claim 1, wherein the support plate is integrated with the frame into a single structure through an insert molding process.

13. A speaker for mobile terminals, comprising:
a frame to define a space therein, with a sidewall extending upward from an outer edge of the frame to a predetermined height;
a first support plate mounted to a lower end of the frame to provide a magnetic circuit;
a first magnet placed at a center of an upper surface of the first support plate, and magnetized in a vertical direction;
an annular second magnet placed to surround the first magnet, and magnetized in a vertical direction so that a magnetic pole direction of the second magnet is opposite to a magnetic pole direction of the first magnet;
a diaphragm provided at a position above the first and second magnets to produce a sound, with a plurality of voice coils being integrally printed on the diaphragm to form a multilayer and generating a predetermined magnetic force by external drive electricity;
a protective plate to cover an open end of the frame;
a second support plate attached to a lower surface of the protective plate to provide a magnetic circuit; and
a third magnet attached to a lower surface of the second support plate, and magnetized in a vertical direction so that a magnetic pole direction of the third magnet is opposite to the magnetic pole direction of the first magnet.

14. The speaker for mobile terminals according to claim 13, wherein the diaphragm comprises:
a first polymeric resin film;
the plurality of voice coils comprising upper and lower voice coils respectively printed on upper and lower surfaces of the first polymeric resin film; and
a second polymeric resin film to cover each of the upper and lower voice coils, thus preventing the upper and lower voice coils from corroding.

15. The speaker for mobile terminals according to claim 14, wherein each of the upper and lower voice coils is printed in a pattern of an eddy, starting from an input terminal or an output terminal provided on an outer portion of the diaphragm so that the external drive electricity is input to the input terminal and output from the output terminal, with a via hole being provided at a center of the eddies of the upper and lower voice coils to conduct the electricity between the upper and lower voice coils printed on the upper and lower surfaces of the first polymeric resin film.

16. The speaker for mobile terminals according to claim 15, wherein a direction of the eddy of the upper voice coil printed on the upper surface of the first polymeric resin film is opposite to a direction of the eddy of the lower voice coil printed on the lower surface of the first polymeric resin film, so that a direction of a current flowing in the upper voice coil is the same as a direction of a current flowing in the lower voice coil.

17. The speaker for mobile terminals according to any one of claims 13 to 16, further comprising:
an auxiliary vibration piece provided at an edge of the diaphragm to allow the diaphragm to smoothly vibrate.

18. The speaker for mobile terminals according to claim 17, wherein the auxiliary vibration piece is made of a soft rubber or an elastomer.

19. The speaker for mobile terminals according to claim 13, wherein the first support plate comprises a support protrusion to support the first and second magnets at desired positions on the first support plate so that an air gap is defined between the first and second magnets.

20. The speaker for mobile terminals according to claim 19, further comprising:
an air hole provided at a predetermined portion of the support protrusion to allow atmospheric air to circulate through the air gap when the diaphragm vibrates.

21. The speaker for mobile terminals according to claim 13, further comprising:
a plurality of air holes provided at predetermined positions of the frame.

22. The speaker for mobile terminals according to claim 13, wherein the first support plate is integrated with the frame into a single structure through an insert molding process.

23. The speaker for mobile terminals according to claim 13, wherein an inner edge of the frame and an outer edge of the first support plate have corresponding slant surfaces so that the first support plate is assembled with the frame at the slant surfaces.

24. The speaker for mobile terminals according to claim 13, wherein an inner edge of the frame and an outer edge of the first support plate have corresponding stepped surfaces so that the first support plate is assembled with the frame at the stepped surfaces.

25. The speaker for mobile terminals according to claim 13, wherein the second support plate is integrated with the protective plate into a single structure through an insert molding process.

26. A speaker for mobile terminals, comprising:
a frame to define a space therein, with a sidewall extending upward from an outer edge of the frame to a predetermined height;
a first support plate mounted to a lower end of the frame to provide a magnetic circuit;
a first magnet placed at a center of an upper surface of the first support plate, and magnetized in a vertical direction;
an annular second magnet placed to surround the first magnet, and magnetized in a vertical direction so that a magnetic pole direction of the second magnet is opposite to a magnetic pole direction of the first magnet;
a diaphragm provided at a position above the first and second magnets to produce a sound, with a plurality of voice coils being integrally printed on the diaphragm to form a multilayer and generating a predetermined magnetic force by external drive electricity;
a protective plate to cover an open end of the frame;
a second support plate attached to a lower surface of the protective plate to provide a magnetic circuit;
a third magnet attached to a lower surface of the second support plate, and magnetized in a vertical direction so that a magnetic pole direction of the third magnet is opposite to the magnetic pole direction of the first magnet; and
an annular fourth magnet placed to surround the third magnet, and magnetized so that a magnetic pole direction of the fourth magnet is opposite to the magnetic pole direction of the third magnet.

27. The speaker for mobile terminals according-to claim 26, wherein the diaphragm comprises:
a first polymeric resin film;
the plurality of voice coils comprising upper and lower voice coils respectively printed on upper and lower surfaces of the first polymeric resin film; and
a second polymeric resin film to cover each of the upper and lower voice coils, thus preventing the upper and lower voice coils from corroding.

28. The speaker for mobile terminals according to claim 27, wherein each of the upper and lower voice coils is printed in a pattern of an eddy, starting from an input terminal or an output terminal provided on an outer portion of the diaphragm so that the external drive electricity is input to the input terminal and output from the output terminal, with a via hole being provided at a center of the eddies of the upper and lower voice coils to conduct the electricity between the upper and lower voice coils printed on the upper and lower surfaces of the first polymeric resin film.

29. The speaker for mobile terminals according to claim 28, wherein a direction of the eddy of the upper voice coil printed on the upper surface of the first polymeric resin film is opposite to a direction of the eddy of the lower voice coil printed on the lower surface of the first polymeric resin film, so that a direction of a current flowing in the upper voice coil is the same as a direction of a current flowing in the lower voice coil.

30. The speaker for mobile terminals according to any one of claims 26 to 29, further comprising:
an auxiliary vibration piece provided at an edge of the diaphragm to allow the diaphragm to smoothly vibrate.

31. The speaker for mobile terminals according to claim 30, wherein the auxiliary vibration piece is made of a soft rubber or an elastomer.

32. The speaker for mobile terminals according to claim 26, wherein the first support plate comprises a support protrusion to support the first and second magnets at desired positions on the support plate so that an air gap is defined between the first and second magnets.

33. The speaker for mobile terminals according to claim 32, further comprising:
an air hole provided at a predetermined portion of the support protrusion to allow atmospheric air to circulate through the air gap when the diaphragm vibrates.

34. The speaker for mobile terminals according to claim 26, further comprising:
a plurality of air holes provided at predetermined positions of the frame.

35. The speaker for mobile terminals according to claim 26, wherein an inner edge of the frame and an outer edge of the first support plate have corresponding slant surfaces so that the first support plate is assembled with the frame at the slant surfaces.

36. The speaker for mobile terminals according to claim 26, wherein an inner edge of the frame and an outer edge of the first support plate have corresponding stepped surfaces so that the first support plate is assembled with the frame at the stepped surfaces.

37. The speaker for mobile terminals according to claim 26, wherein the first support plate is integrated with the frame into a single structure through an insert molding process.

38. The speaker for mobile terminals according to claim 26, wherein the second support plate is integrated with the protective plate into a single structure through an insert molding process.

39. A method of manufacturing a speaker for mobile terminals, comprising:
forming a frame to be integrated with a support plate which provides a magnetic circuit;
attaching a first magnet vertically magnetized to an upper surface of the support plate, and attaching a second magnet, magnetized in a direction opposite to a magnetic pole direction of the first magnet, to the upper surface of the support plate so that the second magnet is spaced apart from the first magnet at a predetermined interval;
forming upper and lower voice coils on upper and lower surfaces of a first polymeric resin film to provide a multilayer, and laminating second polymeric resin films to prevent corrosion of the upper and lower voice coils and insulate the upper and lower voice coils, thus forming a diaphragm;
attaching the diaphragm to the frame so that an outer edge of the diaphragm is supported by an upper end of the frame;
placing a protective plate on the frame to cover an open end of the frame; and
welding input and output terminals of the upper and lower voice coils to a terminal piece of a printed circuit board (PCB).

40. The method of manufacturing the speaker according to claim 39, wherein the forming of the diaphragm comprises:
coating an adhesive agent on the upper and lower surfaces of the first polymeric resin film, and attaching a copper film to each of the upper and lower surfaces of the first polymeric resin film; and
etching a surface of the copper film, thus forming a pattern of each of the upper and lower voice coils.

41. The method of manufacturing the speaker according to claim 39 or 40, wherein the forming of the diaphragm comprises:
printing each of the upper and lower voice coils in a pattern of an eddy; and
forming a via hole at a center of the eddy to conduct electricity between the upper and lower voice coils printed on the upper and lower surfaces of the first polymeric resin film.

42. The method of manufacturing the speaker according to claim 41, wherein the forming of the diaphragm comprises:
printing the upper and lower voice coils on the upper and lower surfaces of the first polymeric resin so that a direction of the eddy of the upper voice coil is opposite to a direction of the eddy of the lower voice coil, and thus a direction of a current flowing in the upper voice coil is the same as a direction of a current flowing in the lower voice coil.
